(19) United States
(12) Patent Application Publication
(10) Pub. No.: US 2015/0296440 A1
(43) Pub. Date: Oct. 15, 2015

(54) Hierarchical Access Network Discovery and Selection Function and Offload Wi-Fi Network

(71) Applicants: Mika Forssell, Porvoo (FI); Jari Pekka Mustajarvi, Espoo (FI); Janne Petteri Tervonen, Espoo (FI)

(72) Inventors: Mika Forssell, Porvoo (FI); Jari Pekka Mustajarvi, Espoo (FI); Janne Petteri Tervonen, Espoo (FI)

(21) Appl. No.: 14/413,038

(22) PCT Filed: Jul. 6, 2012
(86) PCT No.: PCT/EP2012/063336

§ 371 Date: Apr. 8, 2015

(51) Int. Cl. H04W 48/08; H04L 29/08; H04W 48/18; H04W 72/04; H04W 48/04

(52) U.S. Cl. CPC H04W 48/08; H04W 72/0453; H04W 48/04; H04W 48/18; H04L 67/306; H04W 88/06

(57) ABSTRACT

Examples herein propose a hierarchical ANDSF approach in order to provide more online control over user device network/selection. In some embodiments an overall ANDSF server may be a separate ANDSF server or integrated with an ANDSF server in the RAN. In a network of one operator there may be one or more ANDSF and/or RAN-ANDSF servers, for example one RAN-ANDSF server per cell/location/tracking/routing area. Furthermore, a network operator may wish to offload selected users to a Wi-Fi network only when certain conditions are satisfied. For example, if there is congestion in the mobile network, the network operator may wish to offload some of the users to a Wi-Fi network. Therefore, the [RAN-]ANDSF prepares new network selection policies encouraging Wi-Fi usage to the selected users and transmits the policies to the user devices.

This disclosure relates to a method and apparatus and in particular but not exclusively to method and apparatus for use with network discovery and/or selection functions.

A communication system can be seen as a facility that enables communication sessions between two or more entities such as fixed or mobile communication devices, base stations, servers, machine type communication devices and/or other communication nodes. A communication system and compatible communicating entities typically operate in accordance with a given standard or specification which sets out what the various entities associated with the system are permitted to do and how that should be achieved. For example, the standards, specifications and related protocols can define the manner how various aspects of communication such as access to the communication system and feedback messaging shall be implemented between communicating devices. The various development stages of the standard specifications are referred to as releases.

A communication can be carried on wired or wireless carriers. In a wireless communication system at least a part of communications between stations occurs over a wireless link. Examples of wireless systems include public land mobile networks (PLMN) such as cellular networks, satellite based communication systems and different wireless local networks, for example wireless local area networks (WLAN). A wireless system can be divided into cells or other radio coverage or service areas provided by a station. Radio service areas can overlap, and thus a communication device in an area can send and receive signals within more than one station. Each radio service area is controlled by an appropriate controller apparatus. Higher level control may be provided by another control apparatus controlling a plurality of radio service area.

A wireless communication system can be accessed by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station and/or another user equipment.

Wi-Fi networks are becoming an integrated part of mobile broadband. Wi-Fi is a standard feature on some phones such as smart phones, tablets and laptops. Wi-Fi usage is reported to be increasing.

According to an aspect there is provided a method comprising: receiving information at a user equipment; and responsive to said received information causing said UE to obtain from a network discovery and selection function information for network discovery and/or selection.

The information for network discovery and/or selection may comprise policy information for network discovery and/or selection.

The policy information may comprise updated policy information.

The network discovery and/or selection information may be provided for a given location.

The given location may be a cell, a plurality of cells, a routing area, a tracking area, a radio access network area or the like.

The receiving information may comprise monitoring for one or more bits to be set.

In some embodiments, if one or more bits are set, this indicates to a user equipment that there may be new information to be downloaded or available.

In some embodiments, the received information may be broadcast information.

The information may be received in one of a system message, cell broadcast and a radio resource control message.

The causing said UE to obtain said updated policy information may comprise providing said received information to said network discovery and selection function.

The network discovery and selection function may comprise an access network discovery and selection function server.

The network discovery and selection function comprises at least one of a local network discovery and selection function and a global network discovery function.

The at least one local network discovery and selection function and a global selection function may be provided in a common entity.

At least one network discovery and selection function may be provided at a radio access node or a core network node.

The method may comprise determining an occurrence of at least one condition.

The method may comprise receiving said information at said user equipment in response to a determination of an occurrence of at least one condition.

The at least one condition may comprises one or more of network having limited resources available, congestion, reaching of usage limits, use of a particular application, use of a particular type of application and a condition specified in a user profile.

The policy information may comprise at least one of local and global policy information.

According to another aspect, there is provided an apparatus comprising: means for receiving information at a user equipment; and means responsive to said received information for causing said UE to obtain from a network discovery and selection function information for network discovery and/or selection.

The information for network discovery and/or selection may comprise policy information for network discovery and/or selection.

The network discovery and/or selection information may be provided for a given location.

The means for receiving information if for monitoring for one or more bits to be set.

The receiving means may be for receiving said information in one of a system message, cell broadcast and a radio resource control message.

The means for causing may provide said received information to said network discovery and selection function.

The receiving means may receive said information at said user equipment in response to a determination of an occurrence of at least one condition.

The at least one condition may comprise one or more of network having limited resources available, congestion, reaching of usage limits, use of a particular application, use of a particular type of application and a condition specified in a user profile.

The information may comprise at least one of local and global policy information.

According to another aspect, there is provided an apparatus comprising at least one processor and at least one memory including computer code for one or more programs, the at least one memory and the computer code configured, with the at least one processor, to cause the apparatus at least to: cause information to be received; and responsive to said received information cause network discovery and selection function information for network discovery and/or selection to be obtained.

The at least one memory and the computer code may be configured with the at least one processor to cause the apparatus to monitor for one or more bits to be set.

The at least one memory and the computer code may be configured with the at least one processor to cause the apparatus to provide said received information to said network discovery and selection function.

The at least one memory and the computer code may be configured with the at least one processor to cause the apparatus receive said information in response to a determination of an occurrence of at least one condition.

The at least one condition may comprise one or more of congestion, reaching of usage limits, use of a particular application, use of a particular type of application and a condition specified in a user profile.

According to another aspect, there is provided a user equipment comprising any of the apparatus as previously described.

According to another aspect, there is provided a method comprising: providing information on congestion to a global network discovery and selection function; and receiving updated policy information for network discovery and/or selection from said global network discovery and selection function.

According to another aspect, there is provided an apparatus comprising: means for providing information on congestion to a global network discovery and selection function; and means for receiving updated policy information for network discovery and/or selection from said global network discovery and selection function.

According to another aspect, there is provided an apparatus comprising at least one processor and at least one memory including computer code for one or more programs, the at least one memory and the computer code configured, with the at least one processor, to cause the apparatus at least to provide information on congestion to a global network discovery and selection function; and receive updated policy information for network discovery and/or selection from said global network discovery and selection function.

The apparatus may be provided in a local network and discovery function.

According to another aspect, there is provided a method comprising: receiving information about network discovery and/or selection at a user equipment in a radio access network related information.

According to another aspect, there is provided apparatus comprising: means for receiving information about network discovery and/or selection at a user equipment in a radio access network related information.

According to another aspect, there is provided an apparatus comprising at least one processor and at least one memory including computer code for one or more programs, the at least one memory and the computer code configured, with the at least one processor, to cause the apparatus at least to receive information about network discovery and/or selection at a user equipment in a radio access network related information.

According to another aspect, there is provided a method comprising: requesting information about network discovery and/or selection from a network discovery and selection function; and causing information about network discovery and/or selection to be sent to a user equipment in a radio access network related information.

The information about network discovery and/or selection may comprise one or more of global and local policies.

The causing may comprise causing one of a global or local network discovery and selection function to send said information about network discovery and/or selection to be sent to said user equipment.

The information may comprise a management object.

According to another aspect, there is provided an apparatus comprising: means for requesting information about network discovery and/or selection from a network discovery and selection function; and means for causing information about network discovery and/or selection to be sent to a user equipment in a radio access network related information.

According to another aspect, there is provided an apparatus comprising at least one processor and at least one memory including computer code for one or more programs, the at least one memory and the computer code configured, with the at least one processor, to cause the apparatus at least to: request information about network discovery and/or selection from an network discovery and selection function; and cause information about network discovery and/or selection to be sent to a user equipment in a radio access network related information.

A computer program comprising program code means adapted to perform the methods may also be provided.

Various other aspects and further embodiments are also described in the following detailed description and in the attached claims.

Embodiments will now be described in further detail, by way of example only, with reference to the following examples and accompanying drawings, in which:

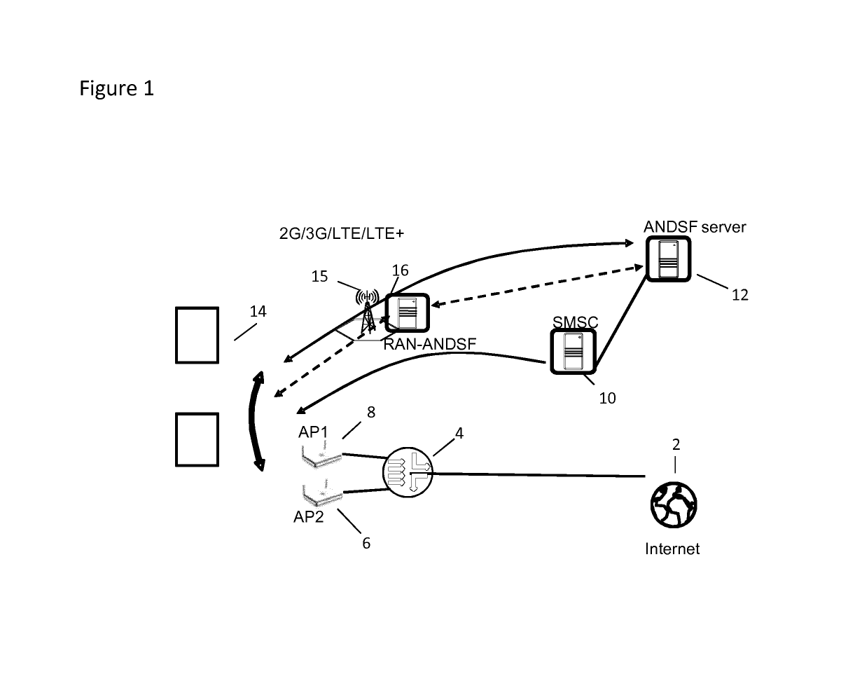

FIG. 1 shows a schematic diagram of the operation and architecture of a first system;

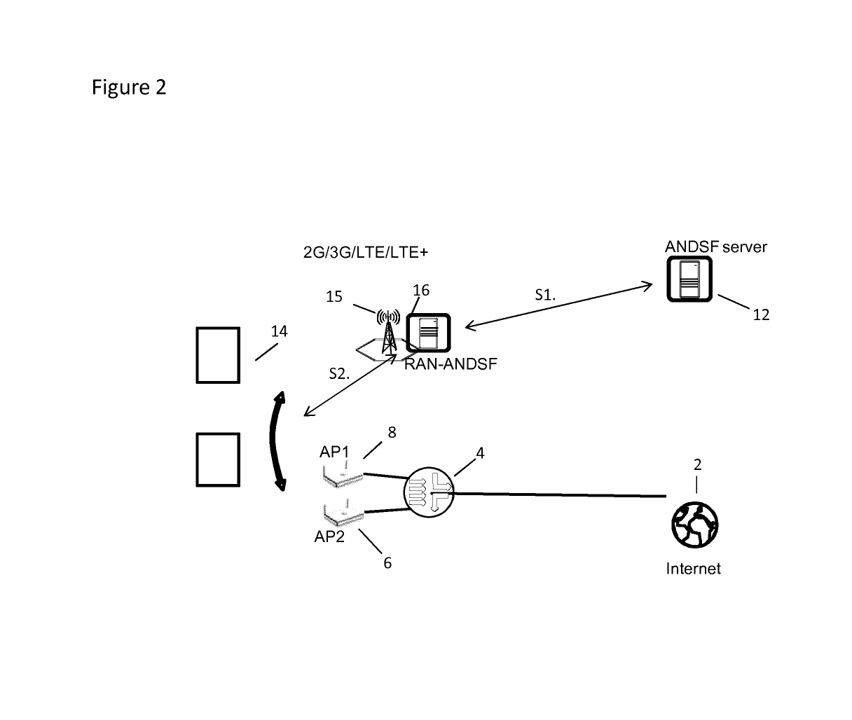

FIG. 2 shows a schematic diagram of the operation and architecture of a second system;

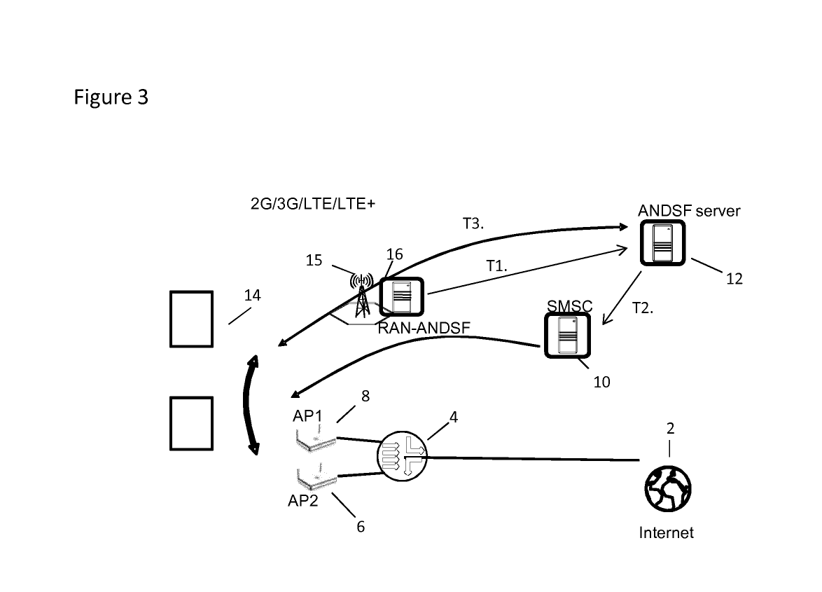

FIG. 3 shows a schematic diagram of the operation and architecture of a third system;

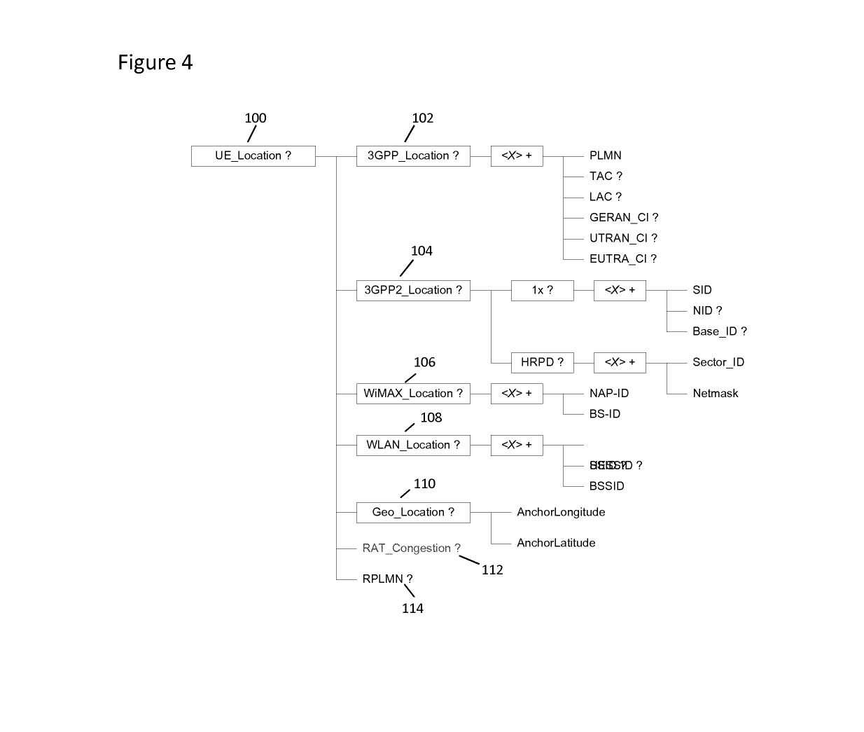

FIG. 4 shows an XML structure in an embodiment;

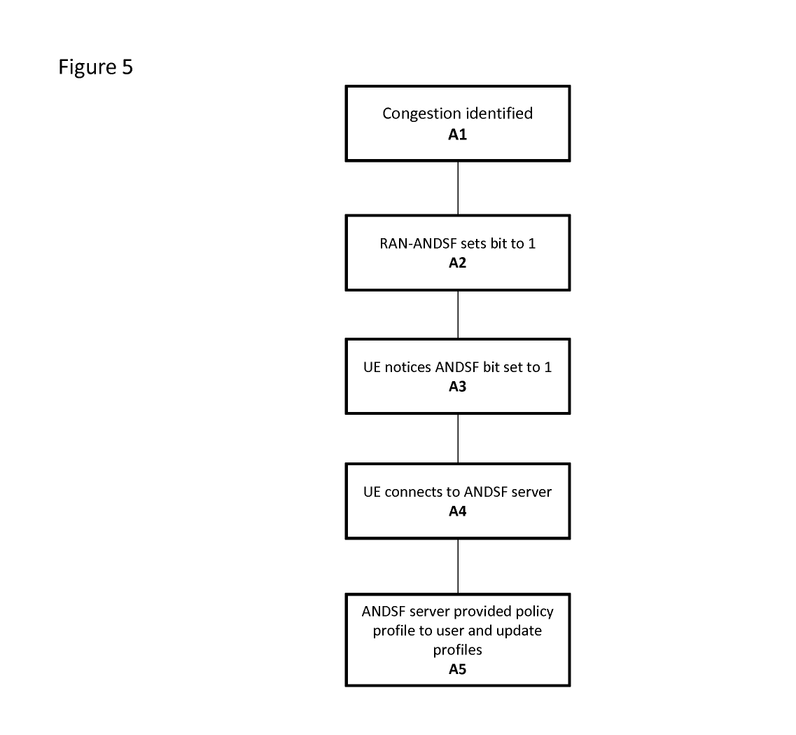

FIG. 5 shows a method of an embodiment; and

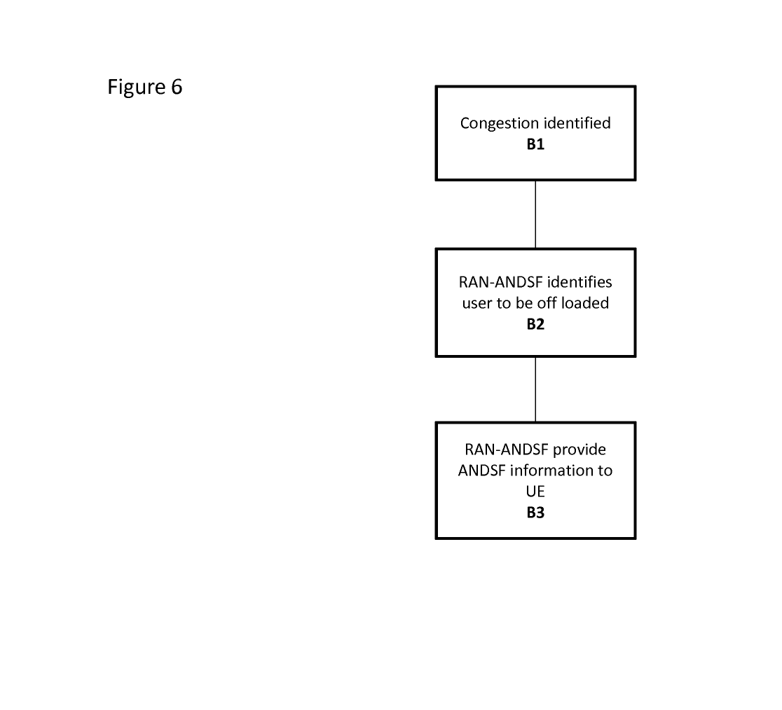

FIG. 6 shows another method of an embodiment.

As Wi-Fi becomes just another cell alongside mobile radio access networks, some operators need to control how the user device or user equipment moves between the mobile and Wi-Fi networks. In some embodiments, dynamic mechanisms may be required in order to control the movement of the user equipment between the mobile and Wi-Fi networks.

For example, a network operator may wish to offload selected users to a Wi-Fi network only when certain conditions are satisfied. For example, if there is congestion in the mobile network, the network operator may wish to offload some of the users to a Wi-Fi network. The access network discovery and selection function ANDSF is an entity which is provided in some 3GPP networks. The ANDSF assists a user equipment to discover non-mobile networks such as Wi-Fi or the like which can be used for data communication instead of or in addition to the mobile network. The ANDSF may provide the user equipment with rules relating to the connection of the user equipment with the Wi-Fi network.

Reference is made to FIG. 1 which shows a sample of a high level network architecture with an ANDSF server and illustrates its operation. The system shown in FIG. 1 comprises user equipment 14. An appropriate mobile device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Non-limiting examples of the content include various downloads, television and radio programs, videos, advertisements, various alerts and other information.

The user equipment is arranged to be able to connect to a first access point or a second access point 6 or 8. The access points 6 and 8 are connected to a router 4 which permits connection to the Internet 2. The access points 6 and 8 along with the router 4 can be considered to provide the Wi-Fi function.

The user equipment 14 is also arranged to an access node 15 of a mobile network. The access node 15 may be a base station, node B or the like. Also provided is a RAN-ANDSF (radio access network-ANDSF). This RAN-ANDSF will be described in more detail later. The RAN-ANDSF is arranged to communicate with an ANDSF server 12.

A SMSC (short message service centre) 10 is provided.

Currently, the 3GPP standard describes some ANDSF functionality provided by an ANDSF server. Currently, the ANDSF server contains all of the ANDSF functionality. However, in some embodiments, a hierarchical ANDSF approach is used to provide more online control over user device network/selection. This may provide an efficient traffic steering method across the mobile and Wi-Fi networks. Thus, a local ANDSF server or functionality is provided. This is referenced RAN-ANDSF 16 in the embodiment shown in FIG. 1. This local ANDSF server functionality may complement the ANDSF server which provides overall network selection rules for the device.

The ANDSF server as specified in current 3GPP standard is used to provide overall and fixed network selection policies to a user device. These policies may include for example the roaming partner Wi-Fi networks the user device should utilize when available, overall network selection policies for operator hotspots, and default network discovery and selection rules for the UE. In some embodiments the overall ANDSF server may be a separate ANDSF server or integrated with the RAN-ANDSF server. In a network of one operator there may be one or more ANDSF and/or RAN-ANDSF servers, for example one RAN-ANDSF server per cell/location/tracking/routing area.

In some embodiments, the RAN-ANDSF functionality may be provided in a server. The RAN-ANDSF function may be located on the RAN (Radio Access Network) level. The RAN-ANDSF may allow the radio access network to participate in decision making as to when the user device uses mobile and Wi-Fi network and/or as to when traffic is offloaded to a Wi-Fi network. In some embodiments, the RAN-ANDSF functionality may be located in an AP integrating a mobile base station (such as an eNB) and a Wi-Fi AP. This combined access point of the cell is aware of resource utilization of both the mobile cell and Wi-Fi AP. In such a case the RAN-ANDSF may also participate into decision making when traffic is offloaded from Wi-Fi to a mobile network when e.g. Wi-Fi utilization is too high. The cells may be considered to be relatively small cells.

In other embodiments, alternatively or additionally ANDSF related functionality may be placed elsewhere in the network, such as the packet core and P-GW/DPI (Packet gateway/Deep Packet Inspection or PCRF (Policy and Charging Rules Function, like PCRF-ANDSF).

The additional ANDSF may provide an operator with a tool to for example:

Offload selected users to a Wi-Fi network when the cell becomes congested;

Offload selected users to a Wi-Fi network when the user uses a particular application. For example video streaming or peer to peer (BitTorrent etc.) may be offloaded to a Wi-Fi network with local breakout, with traffic bypassing mobile radio and core networks;

When the radio/core network becomes short on resources, for example to serve VIP subscribers with an adequate quality of experience, offload selected other user(s) to Wi-Fi;

Offload selected users to Wi-Fi when the user profile indicates to do so. For example, this may be included in a policy charging and rules function PCRF or the like (for example when data cap for a month is used up in the mobile network (e.g. 1 GB/month), Wi-Fi usage is encouraged more, or if a user has used a monthly quota or any defined volume in the Wi-Fi network, the PCRF may trigger a change of ANDSF policies for a particular user to discourage Wi-Fi use to avoid a situation where a UE tries to connect primarily to a hotspot and access is denied as a result of exceeding monthly quota); and/or

Optimized use of available radio networks.

An operator network may contain N local ANDSF functionalities. N may be one or more. In one example, there may be local ANDSF function in the radio access network and one in the packet core network. In the radio access network there may be for example local ANDSF function for one or more relatively small cells AP, per cell, per tracking/location/routing area, per RNC (Radio Network Controller), per base station or the like.

The local-ANDSF functionality can be located for example in a base station. The base station may operate in accordance with any one or more suitable standards such as 2G/3G/LTE/LTE+/Wi-Fi etc. Alternatively or additionally, the local ANDSF functionality maybe provided in a combined mobile base station and Wi-Fi access point.

In some networks such as 3G, a RNC (radio network controller) or similar function may alternatively or additionally host ANDSF functionality to offload selected user(s) in a selected area to Wi-Fi when needed. In some networks, the RNC manages the radio resources of a geographical area.

ANDSF functionality may alternatively or additionally be hosted in a Wi-Fi AP and/or WLAN Controller to control resource usage of the Wi-Fi network. The Wi-Fi AP and/or WLAN Controllers attached to the Wi-Fi AP control the Wi-Fi radio and network utilization and may utilize ANDSF to ensure good quality connections and/or to reduce Wi-Fi utilization if needed (e.g. if there is Wi-Fi congestion).

The ANDSF functionality may be provided in one or more of a P-GW (packet gateway), GGSN (gateway GPRS (general packet radio service) support node), MME (mobility management entity), S-GW (serving gateway), DPI (Deep Packet Inspection) and/or PCRF Wi-Fi AP and/or WLAN Controller. In one or more of these nodes the ANDSF functionality could observe packet core utilization and resources and start offloading selected user(s) to Wi-Fi depending on the usage of the resources.

The 3GPP release 9 ANDSF standard allows a HPLMN operator to utilize the ANDSF server to configure network selection policies to home subscriber devices and VPLMN operator to configure visited-ANDSF policies to visiting subscriber devices. Visited ANDSF may also be overall ANDSF server or local ANDSF server, like RAN-ANDSF.

Referring back to FIG. 1, in this embodiment an operator has one ANDSF server 12 serving the user and also local ANDSF functionality 16 in the RAN to provide an on-demand traffic steering functionality. Reference is also made to FIG. 5 which shows a method of some embodiments.

The RAN-ANDSF provides information to the UEs that can be used to enable dynamic control for Wi-Fi offload. In some embodiments an existing 3GPP RAN mechanism, such as System Information, Cell Broadcast and/or dedicated messaging such as RRC (radio resource control) is used to convey information to the UE about ANDSF usage. In other embodiments, any other suitable mechanism may be used to convey information about the ANDSF usage.

In one embodiment, one or more bits may be provided in one or more of a System Information message, one or more RRC messages and/or other suitable message(s) sent from the network to the UE. These one or more bits tell the UE that the operator has new ANDSF information to download. For example, the new bit could be set when there is congestion in the RAN. In other embodiments, the information may be provided in any other suitable way.

In another embodiment, in case a broadcast method is used to notify UEs about changes in ANDSF policies, like System Information and/or Cell Broadcast messages, the message may contain an information element including a list of identifiers identifying UEs to which ANDSF policy changes apply. The identifiers can be for example a temporary UE/radio network identifier known by RAN. UEs included in the list may take further ANDSF actions while UEs not listed in the list continue their normal operation.

The operator may identify congestion in some area of the RAN in step A1 and cause the RAN-ANDSF 16 to set a RAT congestion for ANDSF bit to ‘1’ in System Information messages for certain cells in step A2. In the ANDSF server 12, the operator has defined for example two different sets of policies, one policy profile for RAT congestion for ANDSF and another for a normal situation and/or default cases guiding UE Wi-Fi use and selection. These profiles may also contain subscriber profile specific information or be default policy profiles for all user devices in a given area. Based on these policy profiles, the ANDSF server can construct localized policies during runtime e.g. based on the location of the UE. The validity of the RAT congestion for ANDSF policies may be limited e.g. by time (for example 15 minutes) or by UE location which may be dependent for example on Cell or Routing/Tracking/etc Identifier.

In step A3, when the UE notices the value of the RAT congestion for the ANDSF bit has been changed to ‘1’ (for example in system information or radio resource management messaging), the UE initiates an ANDSF connection to the ANDSF server 12 in step A4 to download the latest settings. The UE informs the ANDSF server about the value of the RAT congestion for ANDSF bit, e.g. as part of the UE_Location node. The ANDSF Management Object may contain a separate node/leaf for congestion information. This procedure may eliminate the RAN having to identify users to be offloaded and extra communication between RAN-ANDSF and ANDSF server leading to simpler setup. The ANDSF server knows when a UE contacts it based on UE provided information what to do and to which user e.g. congestion ANDSF policies apply, are automatically available without the RAN having to identify users separately.

In some embodiments a message (for example a system information message or a radio resource management message) containing RAT congestion for the ANDSF bit may also define which ANDSF server the UE should be contacting. For example, the URL ANDSF.mccmnccellid.com may lead directly to an area specific RAN-ANDSF instead of a global ANDSF server.

Based on this information, ANDSF will provide a correct policy profile to the UE in step A5. The ANDSF may form the contents of the policy during runtime: for example after reading the UE_Location node, the server can limit the policy profile information to cover only the area where the UE currently is, i.e. the UE gets a localized policy.

Optionally the ANDSF server and RAN-ANDSF may exchange messages and information (represented by the dotted line between the ANDSF server 12 and the RAN-ANDSF server 16), for example upon cell congestion, allowing the ANDSF server 12 to better optimize policies given for user devices in a given location. In such a case ANDSF server knows congestion or other defined situation in a given area (without UE even providing the information to the ANDSF server e.g. by using RAT congestion for ANDSF information).

During the ANDSF session, the ANDSF server may remove obsolete policies from the UE. Localized policies (i.e. policies that the ANDSF server has formed in run time based on the UE_Location information) may be identified with a common priority value range, e.g. 0-20. Higher priorities (for example >20) could then be used for default network selection policies guiding overall UE operation.

Alternatively or additionally the ANDSF server may provide a global policy.

If the UE switches to a new cell, and the UE does not have an active local policy for that area (for example the local policy is not valid any more, or there is no local policy), the UE may contact the ANDSF server for a new policy. Alternatively or additionally the UE may use a default policy, if there is one.

If the UE switches to a new cell, and the UE has a valid local policy and the value of RAT congestion for ANDSF bit is disabled in the new cell, the UE may do nothing. Otherwise the UE may connect to the ANDSF server to receive updated policies for the new cell.

In some embodiments, the RAT congestion for ANDSF bit may represent a larger area than a cell area. In a first option local policy may have a validity condition according to this ‘larger area’ and the ‘RAT congestion for ANDSF’ bit is evaluated against this area and a previous bit value. In a second option, one or more additional bits for ‘RAT congestion coverage” could be used to indicate whether the area consist of current Cell, current TAC, current LAC, current RAC, current PLMN. The number of bits may for example be three in some embodiments. The UE may be configured to convert the one or more additionally bits to real identifiers which may be for example known to the UE such as one or more of Cell ID/TAC/LAC/RAC and/or PLMN or the like from the currently connected cell. If UE enters into new cell and there the RAT congestion for ANDSF′ has same value as in previous cell and a deduced validity area from ‘RA congestion coverage’ bits matches the value in the previous cell, then UE does not need to contact ANDSF server. If the RAT congestion for ANDSF′ bit in the new cell is set, in some embodiments, the UE shall contact ANDSF server and there may be no need to coordinate the ANDSF bit.

In some embodiments the coverage of the RAT congestion for ANDSF′ bit can be reassigned for example to indicate any of the Cell/LAC/TAC/RAC/PLMN coverage to which the cell transmitting the RAT congestion for ANDSF′ bit belongs to a routing area or the like area may have RAT congestion for ANDSF bit that guides UEs. For example when the UE enters the routing area where RAT congestion for ANDSF bit is set, the UE communicates with the ANDSF server to get routing area specific policies. When the UE moves within the routing area, there is no need for the UE to communicate with the ANDSF server unless the RAT congestion for ANDSF bit changes and requires new communication.

To clear the congestion, the RAT congestion for ANDSF bit is set to ‘0’. The UEs may need to contact the ANDSF server after seeing either or both bit value changes (‘0’->‘1’ and/or ‘1’->‘0’) to get the up-to-date policies. As an option, when RAT congestion for ANDSF bit is ‘0’ UE may continue using default policies (e.g. priority >20) to avoid unnecessary ANDSF server communication and optionally internally invalidate local policies (e.g. priority <=20). The UE may not be able to make a continuous ANDSF communication if the congestion bit changes too frequently. The UE may not need to contact the ANDSF server unless it has an active PDN (packet data network) session as an idle US may not need this information. In some embodiments, the UE will check the value of the new RAT congestion for ANDSF bit e.g. once every n minutes to limit ANDSF traffic. By way of example only n may be 10 or the like.

In some embodiments, n may be undefined in which case the UE monitors RAT congestion for ANDSF for example every time when receiving the information in system information, cell broadcast, RRC or the like message.

Alternatively or additionally it is also possible to convey RAT congestion for ANDSF information with Cell Broadcast. Alternatively or additionally it is also possible to convey RAT congestion for ANDSF information to the UE when the UE communicates with the RAN, e.g. via RRC messages. A UE needs to establish bearers when changing to a new cell and this allows the UE to learn quickly up to date RAT congestion for ANDSF status information. For example when UE requests radio bearer establishment to do a location update, handover or data transfer, RAT congestion for ANDSF status information may be provided to the UE. In case RAT congestion for ANDSF status information applies for a larger area, like tracking/routing area, SGSN/MME etc. mobility management element may communicate RAT congestion for ANDSF status information to the UE when UE performs for example Attach or PDP context/Session establishment/update/delete procedures.

Reference is made to the arrangement of FIG. 2. In this example operator has one ANDSF server serving the user and also local ANDSF functionality in the RAN to provide on-demand traffic steering functionality. Reference is also made to FIG. 6 which shows another method of other embodiments.

When the UE connects to a new cell or uses cell resources (for example when initiating a new data connection), the UE communicates with the RAN and for example the RRM (Radio Resource Manager). When the used RAN and/or cell is running short of resources, there may for example be congestion or low bitrates which is identified in step B1. The RAN-ANDSF may identify one or more users of a cell to be offloaded to Wi-Fi in step B2. Then RAN-ANDSF provides in step B3 to the UE ANDSF (or the like) Wi-Fi network discovery and/or selection information in existing RAN messages (like RRC) using 3GPP standardized S14 interface and messaging or any other suitable message(s) exchanged with the UE. The RAN-ANDSF can for example send ANDSF MO (Management Object) as an addition to RRM related messages (like RRC). In some embodiments, the ANDSF MO may be included as a new information element into RRC message.

Any other information may alternatively or additionally be provided in step B3. The information may be ANDSF information. The information may be network discovery and/or selection information. The information may be network discovery and/or selection information for a Wi-Fi network.

In order to create ANDSF MO content to be transmitted to the UE one or both of the following options may be used.

The RAN-ANDSF requests the ANDSF server to create ANDSF MO for a particular user with updated policies. This is referenced S1 in FIG. 2. The local ANDSF RAN related policies may be marked as temporary by limiting their use with time of day and/or location and/or when particular conditions occur. Once RAN-ANDSF obtains the ANDSF MO from the ANDSF server, the RAN-ANDSF sends the ANDSF MO to the UE in RAN related message (like RRC), see step S2 of FIG. 2. Steps S1 and S2 may be considered as part of step B3. In the communication (S1) RAN-ANDSF provides to ANDSF server local information guiding ANDSF MO creation within ANDSF server. The ANDSF server 12 may operate in one or more modes: 1) ANDSF server uses the RAN-ANDSF provided local policies to create overall ANDSF MO provided to the UE that may contain also non-local policies (for example user profile input into local/overall policies) 2) RAN-ANDSF may provide ANDSF MO for ANDSF server that contains ready-made local ANDSF policies which the ANDSF server may then include into final ANDSF MO as such and optionally complement this with other overall policies and/or user profile information (e.g. local policies use priority <=20).

As an option, the RAN-ANDSF and UE may also communicate directly using 3GPP standardized S14 interface. For example UE may be connected to Wi-Fi AP when detecting the need to communicate with an ANDSF server (in this case RAN-ANDSF) and thus use IP communication. When UE uses Wi-Fi it still often able to monitor system information messages, paging channel and be even engaged in mobile communication (multi-radio UE). Thus UE may be aware of RAT changes ANDSF bit changes.

The UE may also use the mobile network when communicating directly to RAN-ANDSF server. In this case, the RAN-ANDSF server needs to be reachable towards to UE. In such a case, the ANDSF communication can take place normally via GGSN/P-GW or local breakout (3GPP LIPA/SIPTO) technologies can be used where the base station or other element routes ANDSF messaging directly to RAN-ANDSF server without the packets going through GGSN/P-GW as such.

In some embodiments the ANDSF operation is changed to allow use of a plurality of ANDSF MOs coming from different sources. The ANDSF server has provided to the UE default network discovery and selection policies and the RAN-ANDSF complements this by sending the ANDSF MO containing temporary local ANDSF policies, which take priority over the default ANDSF MO policies but do not replace the default ANDSF MO policies.

Reference is made to FIG. 3. In this example, the operator network contains a default ANDSF server 12 and in addition local ANDSF servers 16 in the mobile RAN.

The ANDSF server 12, as currently standardized in 3GPP, providing overall network selection policies optionally complements the below described local-ANDSF servers. This may enable more dynamic network selection rule setting in user devices.

The ANDSF server 12 defines e.g. operator hotspots and their selection rules for users who have a subscription to the Wi-Fi service. This causes these devices to use proactively Wi-Fi when available.

The ANDSF server 12 defines policies for using roaming partner Wi-Fi networks to selected user devices. For example a mobile operator defines a particular Wi-Fi system and usage criteria for selected user devices enabling Wi-Fi hotspot usage for these users.

The RAN-ANDSF server functionality may be implemented in NB, eNB, RNC, or another suitable network element. During a power-up procedure or the like, nearby Wi-Fi network information (such as SSID (service set identifier), optionally location or the like) is configured into the RAN-ANDSF server.

There may be for example a radio level mapping table where a defined cell/location area is mapped to a number of Wi-Fi APs. For example cell IDs in a train station are mapped to Wi-Fi APs in the train station.

When RRM (Radio Resource Manager, or the like functionality) in a mobile network element (like eNB or RNC) detects a shortage or a potential shortage on radio access network (RAN) resources, e.g. radio resource utilization exceeds a threshold (like 70% or a UE requested QoS (quality of service) can no longer be met) or there are important users to which service level needs to be guaranteed, 1-N users are identified that should be offloaded to nearby Wi-Fi network

The RRM may trigger the RAN-ANDSF server to initiate offload to Wi-Fi for selected user(s). The RRM (or other functionality) provides user ID (e.g. MSISDN, IMSI . . . ) to RAN-ANDSF server for each user to be offloaded. Offloading only selected users provided finer granularity of control and allows e.g. ensuring service level for important users and using subscription profile in making offloading decisions.

The RAN-ANDSF prepares new network selection policies encouraging Wi-Fi usage to the selected users and transmits the policies to the user devices according to the ANDSF standard or using RRC etc. messages used in direct communication with the UE. RAN-ANDSF sets for example one or more or the following policies to selected user devices:

SSID or the like information is defined for the nearby Wi-Fi networks where offload is targeted:

Time of day: Set to current date and defines that offload policy is valid only for the next 15 minutes s or other time period;

Geographical area is used to limit the offload e.g. to train station; and/or

Any other location based validity condition.

As a result, user devices detecting nearby Wi-Fi networks match their newly established network selection policies and start offloading traffic to the Wi-Fi networks according to policies. This leaves more resources on mobile radio access network to serve better the remaining mobile users.

As an option, the RAN-ANDSF server 16 may request the ANDSF server 12 to configure selected UEs 14 and give the ANDSF server 12 either parameters to be transmitted to UEs (that ANDSF server uses to formulate ANDSF Management Object (MO)) or RAN-ANDSF can formulate ANDSF MO content for the ANDSF server to provide to selected UEs. In this case the RAN-ANDSF does not have to implement OMA DM (Open Mobile Alliance Device management) or the like communication method for exchanging messages directly with the user device.

In FIG. 3, in step T1 the RAN-ANDSF 16 requests the ANDSF server to send defined policies to selected UEs.

In step T2, the ANDSF server 12 sends a SMS (short message service) to the UE requesting UE to establish an IP connection to the ANDSF server. The message is sent via the SMSC 10.

In step T3, the ANDSF MO including the local RAN-ANDSF policies is transferred to the UE from the ANDSF server 12.

In the described embodiments information is described as being provided by a bit. It should be appreciate that the information may be provided by more than one bit or by any other suitable way. In some embodiments, example values of bits are given. It should be appreciated that in other embodiments, different values for the bit may be used to convey particular information.

In other embodiments, there may be a packet core local ANDSF function. The PGW-ANDSF server functionality may be implemented in P-GW (and/or GGSN-ANDSF, SGW-ANDSF, DPI-ANDSF PCRF-ANDSF and/or MME-ANDSF). The DPI may be a separate function or element.

During element power-up procedure, pre-configured Wi-Fi network selection profiles (such as predefined SSIDs, predefined applications and/or the like) are configured into the local-ANDSF server. There can be for example application mapping. For example for video streaming Wi-Fi is encouraged to be used.

When DPI (Deep Packet Inspection, or the like functionality) in a packet core network element (such as a P-GW) detects certain criteria being fulfilled. The criteria may be any suitable criteria such as a heavy load or somebody uses video streaming with a high quality, the given user is identified and is offloaded to a nearby Wi-Fi network

The DPI will trigger the PGW-ANDSF server to initiate offload to Wi-Fi for selected user(s).

The PGW-ANDSF prepares network selection policies encouraging Wi-Fi usage to the selected user(s) and transmits the policies to the user devices according to ANDSF standard. PGW-ANDSF may set for example one or more of the following policies to selected user devices.

The SSID etc. information is defined for the Wi-Fi networks where offload is targeted.

Application identity—defines for example that for a given video streaming application, that traffic is offloaded to Wi-Fi while other traffic is kept in mobile.

Time of day—set to current date and defines that offload policy is valid only for the next N minutes/hours. N can be any suitable time period.

Geographical area is used to limit the offload e.g. to train station.

Seamless or Non-seamless policies may be given to affect if traffic is routed from Wi-Fi network directly to Internet or if traffic is integrated into packet core network.

As a result, offload to Wi-Fi occurs, for example, for the Video user when his device detects a nearby Wi-Fi network matching the newly established network selection policies.

As an option, the PGW-ANDSF server may request the ANDSF server to configure selected UEs and give the ANDSF server either parameters to be transmitted to UEs (that ANDSF server uses to formulate ANDSF Management Object (MO)) or PGW-ANDSF can formulate ANDSF MO content for the ANDSF server to provide to selected UEs.

Another packet core or RAN related example includes PCRF functionality. For example when a monthly quota is used, the PCRF may trigger PCRF-ANDSF to provide new Wi-Fi selection rules to these devices. For example when the mobile quota is used, Wi-Fi usage is encouraged more by triggering transmission of new ANDSF policies to UE. Alternatively or additionally when a Wi-Fi monthly quota is used, the PCRF-ANDSF triggers the changing of UE ANDSF policies in a way that UE no longer has access to operator hotspots during the rest of the month as AAA (authentication, authorization and accounting) would reject the access (because of the exceeded monthly quota).

As an option, a local ANDSF functionality/server can be implemented as a plug-in into RAN, packet core etc. that communicates with the ANDSF server. Local ANDSF server can provide details (such as user ID, detailed network selection policy information, location) to the ANDSF server which provides a common place for configuring network selection policies for user devices. The local-ANDSF server detects the need to provide local policies to selected user(s) and triggers the ANDSF server to make the necessary provision.

Alternatively or additionally where the RAN-ANDSF server runs as a separate local ANDSF server in addition to the ANDSF server, the following local ANDSF discovery method may be used by user devices allowing the devices to discover first the local ANDSF and only then the ANDSF server providing overall network selection policies:

When the user device contacts the ANDSF server, the user device extends the ANDSF server name with the local radio access network identifier information, for example cell ID or location/routing area ID. For example mccmnc.ANDSF.com becomes mccmnc.cellid.ANDSF.com or mccmnc.rac.ANDSF.com. This allows the user device to find the local ANDSF when needed.

As an option, the ANDSF server to be contacted can be indicated to UE in system information, cell broadcast, RRC etc. message for example by including URL into the message, like mccmnc.cellid.ANDSF.com. This causes the UE to contact the specified ANDSF server.

In some embodiments, a standardized FQDN format is andsf.mnc<MNC>.mcc<MCC>.pub.3gppnetwork.org. The device applying to a local andsf scheme and directly accessing local andsf would use ci<CI>.tac<TAC>.andsf.mnc<MNC>.mcc<MCC>.pub.3gppnetwork.org for LTE networks. Similarly a 2G and/or 3G specific identifier could be used instead of TAC in those networks. In some embodiments, there may be a detailed network identity available in the FQDN.

In some embodiments the FDQN format may comprise the cell specific identifiers.

Having a small ANDSF server could cause problems as the UE needs to be bootstrapped for each server separately. In order to avoid constant bootstrapping, local ANDSF servers could share UE specific security keys with the global ANDSF server. In this case the UE would use global andsf.mnc<MNC>.mcc<MCC>.pub.3gppnetwork.org FQDN in the key generation (bootstrap) process and a local ANDSF server would receive the keys from global ANDSF server.

The 3GPP specifications for ANDSF provide two mechanisms for authentication, service authorisation and communication protection. GAA bootstrapping as described in 3GPP TS33.220 and TS33.222 allows both parties to learn a shared secret which is used to protect the communication and to implicitly allow both parties to authenticate one another by means of knowledge of the shared secret. The ANDSF FQDN is used as an input key to generate the shared secret. The GAA is based on a SIM based authentication mechanism. OMA DM bootstrapping as described in OMA-ERELD-DM-V1_{—}2:“Enabler Release Definition for OMA Device Management” allows ANDSF servers to share the login credentials of the users and of the server. The credentials are delivered to the UE from the server prior to authentication. This allows both endpoints to mutually authenticate themselves. This provides a mutual authentication when the SIM card is not used for authentication purposes. In both authentication mechanisms, if the server certificate based https is used, the server certificate shall contain all ANDSF FQDN's which are used by the operation. Alternatively a standard ANDSF FQDN must be used in http hearers instead of a real cell specific ANDSF FQDN. The https server then verifies this name against the server certificate as both must have the same name.

When the user device does not locate a local ANDSF or for example wants to receive non-local policies, the user device contacts the ANDSF server as currently specified in 3GPP, for example using mccmnc.ANDSF.com to resolve the ANDSF server IP address.

Alternatively or additionally to find if a packet core specific local ANDSF server exists and contact that entity, the APN (Access Point Name) or the like which the UE is currently using could be utilized: mccmnc.apn.ANDSF.com.

The value of RAT congestion for ANDSF bit may be added into ANDSF MO structure. One possible way to do that is illustrated in the following FIG. 4.

FIG. 4 shows an example of a ANDSF MO (Management Object) containing XML structure for ANDSF information. The XML structure is for user equipment location 100. The XML file contains elements—3GPP location 102, 3GPP 2 location 104, WiMax location 106, WLAN location 108, geographic location 110, RAT (radio access technology) congestion 112 and RPLMN (registered public land mobile network) 114. The element 112 is an example which provides a container for RAT congestion specific information exchanged between UE and (RAN-) ANDSF server. Some of the elements such as 3GPP location 102 and the like may have sub elements for various options.

The required data processing apparatus and functions of an apparatus in a network element and/or a mobile device for the causing configuration, signaling, determinations, and/or control of measurement and reporting and so forth may be provided by means of one or more data processor. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

An appropriately adapted computer program code product or products may be used for implementing the embodiments, when loaded or otherwise provided on an appropriate data processing apparatus. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments may be practiced in various components such as integrated circuit modules. The design of integrated circuits is by and large an automated process. Complex and powerful tools are available for converting a logic level design into a semiconductor circuit design ready to be formed on a semiconductor substrate.

It is noted that whilst embodiments have been described in relation to HSUPA, similar principles can be applied to any other communication system. Therefore, although certain embodiments were described above by way of example with reference to certain exemplifying architectures for wireless networks, technologies and standards, embodiments may be applied to any other suitable forms of communication systems than those illustrated and described herein. Whilst the above embodiments have been described in relation to uplink communications, some embodiments may be used in downlink communications.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. For example, a combination of one or more of any of the other embodiments previously discussed can be provided. All such and similar modifications of the teachings of this invention will still fall within the scope of this invention as defined in the appended claims.

1. A method comprising:
receiving information at a user equipment; and
responsive to said received information causing said UE to obtain from a network discovery and selection function information for network discovery and/or selection.

2. A method as claimed in claim 1, wherein said information for network discovery and/or selection comprises policy information for network discovery and/or selection.

3. A method as claimed in claim 1, wherein said network discovery and/or selection information is provided for a given location.

4. A method as claimed in claim 1, wherein said receiving information comprises monitoring for one or more bits to be set.

5. A method as claimed in claim 1, wherein said information is received in one of a system message, cell broadcast and a radio resource control message.

6. A method as claimed in claim 1, wherein said causing said UE to obtain said updated policy information comprises providing said received information to said network discovery and selection function.

7. A method as claimed in claim 1 wherein said network discovery and selection function comprises an access network discovery and selection function server.

8. A method as claimed in claim 1, wherein said network discovery and selection function comprises at least one of a local network discovery and selection function and a global network discovery function.

9. A method as claimed in claim 8, wherein at least one local network discovery and selection function and a global selection function are provided in a common entity.

10. A method as claimed in claim 1, wherein at least one network discovery and selection function is provided at a radio access node or a core network node.

11. A method as claimed in claim 1, comprising determining an occurrence of at least one condition.

12. A method as claimed in claim 1, comprising receiving said information at said user equipment in response to a determination of an occurrence of at least one condition.

13. A method as claimed in claim 11, wherein said at least one condition comprises one or more of congestion, reaching of usage limits, use of a particular application, use of a particular type of application and a condition specified in a user profile.

14. A method as claimed in claim 1, wherein said information comprises at least one of local and global policy information.

15. A computer program comprising computer executable instructions which when run cause the method of claim 1 to be performed.

16. An apparatus comprising at least one processor and at least one memory including computer code for one or more programs, the at least one memory and the computer code configured, with the at least one processor, to cause the apparatus at least to:
cause information to be received; and
responsive to said received information cause network discovery and selection function information for network discovery and/or selection to be obtained.

17. An apparatus as claimed in claim 16, wherein the at least one memory and the computer code are configured with the at least one processor to cause the apparatus to monitor for one or more bits to be set.

18. An apparatus as claimed in claim 16, wherein the at least one memory and the computer code are configured with the at least one processor to cause the apparatus to provide said received information to said network discovery and selection function.

19. An apparatus as claimed in claim 16, wherein the at least one memory and the computer code are configured with the at least one processor to cause the apparatus receive said information in response to a determination of an occurrence of at least one condition.

20. Apparatus as claimed in claim 19, wherein said at least one condition comprises one or more of congestion, reaching of usage limits, use of a particular application, use of a particular type of application and a condition specified in a user profile.

21. (canceled)
